(19) United States
(12) Patent Application Publication
(10) Pub. No.: US 2017/0320492 A1
(43) Pub. Date: Nov. 9, 2017

(54) Apparatus For Automatic Collision Avoidance

(71) Applicant: CNH Industrial America LLC, New Holland, PA (US)

(72) Inventors: Luca Ferrari, Formigine (IT); Riccardo Morselli, San Vito Di Spilamberto (IT)

(73) Assignee: CNH Industrial America LLC, New Holland, PA (US)

(21) Appl. No.: 15/588,133

(22) Filed: May 5, 2017

(30) Foreign Application Priority Data
May 6, 2016 (IT) 102016000046661

(51) Int. Cl. B60W 30/09; B60W 10/18; B60W 50/00; B60W 10/20; B60W 30/095

(52) U.S. Cl. CPC B60W 30/09; B60W 10/20; B60W 30/095; B60W 50/0097; B60W 10/18; B60W 2550/10; B60W 2710/18; B60W 2710/20; B60W 2720/10; B60W 2300/15

(57) ABSTRACT

An apparatus for automatic collision avoidance, to be provided on a vehicle, includes a processing unit and a detection means for detecting positions of obstacles within an area of interest. The processing unit includes a position module configured for acquiring a current position of the vehicle, a speed module configured for acquiring a current speed of the vehicle, a steer module configured for acquiring a current steering degree of the vehicle, and a risk area module configured for calculating current possible trajectories of the vehicle according to values of said current position, speed and steering degree, thereby defining a current collision risk area.

### PRIORITY CLAIM

This application claims priority to Italian Patent Application No. 102016000046661, entitled “APPARATUS FOR AUTOMATIC COLLISION AVOIDANCE,” filed May 6, 2016, which is incorporated herein by reference.

### BACKGROUND

The invention relates to a method and an apparatus for automatic collision avoidance to be provided on vehicles, particularly construction vehicles, like excavators or the like and agricultural vehicles, such as tractors, combines, etc.

In the automotive field, adaptive cruise control (ACC) systems have been recently introduced, which provide automatic braking or dynamic set-speed type controls for cars and the like. The ACC system uses e.g. a laser setup in order to allow a car to keep pace with another car it is following, so as to slow when closing in and accelerating to the preset speed when traffic allows.

Although this solution works fine in the automotive field, it has not been adopted in the fields of construction or agricultural equipment, where the need is felt of a system which enable the vehicle, and its operator, to deal with the peculiarities of construction sites or agricultural fields. In fact, if by way of example an excavator moves in a construction site, especially driving in reverse, it might run into a building or a pole or it might cross the path of another excavator or of a pedestrian worker or of a worker on a bicycle and so on.

These specific issues do not arise when driving a car on roadways. Currently, in constructions sites or agricultural lands, collisions are avoided thanks to operator's individual skills, which is not an enough reliable solution. Therefore, as anticipated above, the need is still felt of a system for the automatic collision avoidance, able to also work in the technical fields of construction or agriculture.

It is an object of the present invention to provide an apparatus and a method for collision avoidance able to satisfy the above-cited need. This object is achieved by the apparatus realized in accordance with claim 1.

### DRAWINGS

These and other features, aspects, and advantages of the present invention will become better understood when the following detailed description is read with reference to the accompanying drawings in which like characters represent like parts throughout the drawings, wherein:

FIG. 1 is a diagram representing the apparatus of the invention.

FIG. 2 is a schematic view of a vehicle and of its collision risk area calculated by the apparatus.

FIG. 3 is a schematic view of the vehicle of FIG. 2 and of the travel area of a pedestrian calculated by the apparatus.

FIG. 4 is schematic view of the vehicle and the pedestrian of FIGS. 2 and 3, and of the intersection between the collision risk area and the travel area.

FIG. 5 is diagram representing a classification of possible actions to be taken according to an estimated deceleration of the vehicle needed in order to avoid a collision.

FIG. 6 is a schematic view of a vehicle and of a proximity range calculated by the apparatus of the invention in order to deal with possible sudden appearance of a pedestrian or other obstacles very close to the vehicle itself.

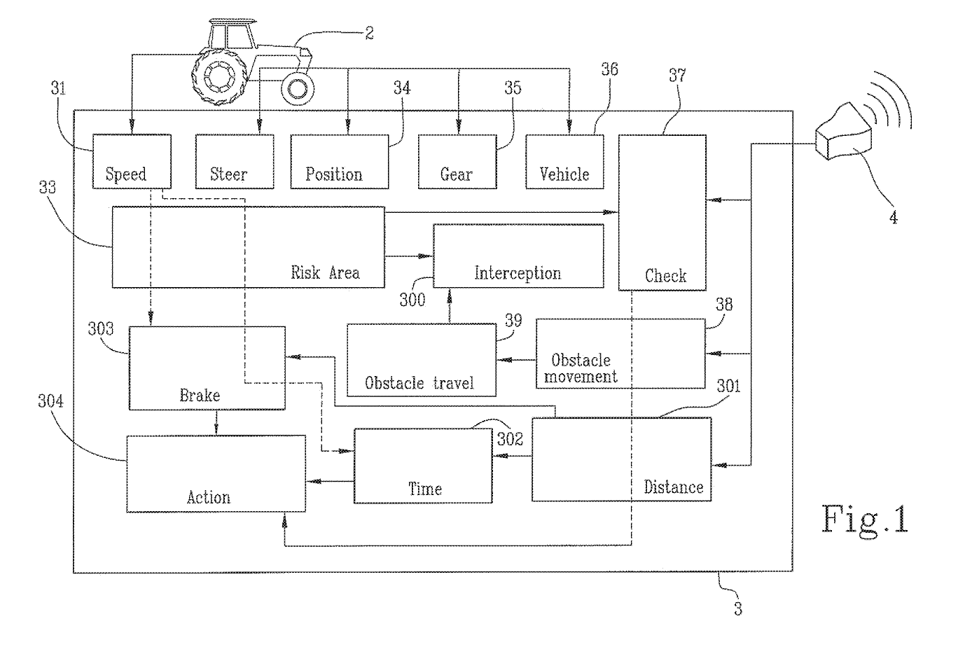

### DETAILED DESCRIPTION

With reference to the aforementioned figures, 1 indicates the apparatus for automatic collision avoidance, according to the invention. The apparatus 1 is intended to be provided on a vehicle 2, especially construction vehicles, like excavators or the like and agricultural vehicles, such as tractors, combines, etc.

The apparatus 1 also includes a processing unit 3, comprising a plurality of operative modules and, preferably, at least a memory module. Please note that, in the present description, the processing unit 3 is presented as articulated into distinct operative modules in order to describe it in a clear and complete way. In practice, the processing unit may be constituted by a single electronic device, also of the type commonly present on this type of machines (like an ECU), programmed to perform the functionalities described. Different modules can correspond to respective hardware entities and/or software routines that are part of the programmed device. Alternatively or in addition, such features can be carried out by a plurality of electronic devices on which the aforesaid operative modules are included.

In general, the processing unit 3 may use one or more microprocessors for the execution of instructions contained in memory modules and the above operative modules can also be distributed over a plurality of computers in a local or remote according to the network architecture in which they are provided.

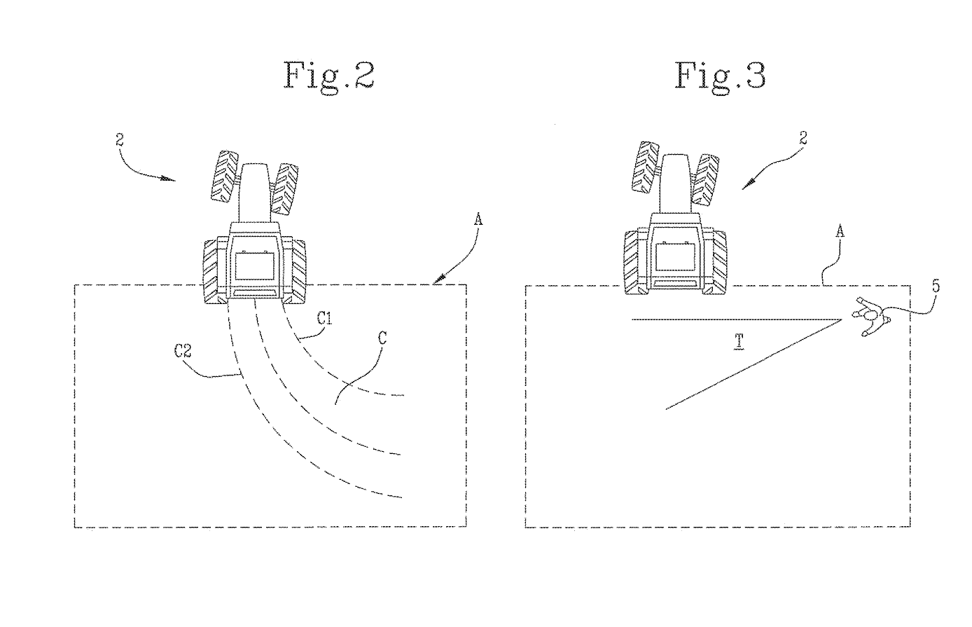

The processing unit 3 of the invention comprises: a position module 34 configured for acquiring a current position of the vehicle 2; a speed module 31 configured for acquiring a current speed of the vehicle 2; a steer module 32 configured for acquiring a current steering degree of the vehicle 2; and a risk area module 33 configured for calculating current possible trajectories of the vehicle 2 according to said current position, the values of said current speed and steering degree, thereby defining a current collision risk area C (see FIG. 2).

The processing unit 3 can be part of, or connected to, or replace the ECU (Engine Control Unit) of the vehicle 2 and acquiring the information (or parameters) relating the speed and the steering degree from the ECU itself (e.g. via CAN buses or the like) or the sensors usually provided for detecting those physical quantities.

Processing this information, the risk area module 33 can determine which possible trajectories the vehicle 2 can cover in the near future (e. g. within a preset time window or within a preset interesting range). In order to define the collision risk area C, the processing unit 3 comprises said a position module 34, which is configured for acquiring a current position of the vehicle 2 (e.g. by means of GPS-like devices), a gear module 35 configured for acquiring information relating to the direction of travel (e.g. forward or reverse) and possibly a vehicle module 36 configured for acquiring physical parameters of the vehicle 2 for which the apparatus 1 is intended.

According to the information acquired, the risk area module 33 can calculate a plausible set of trajectories that the vehicle 2 can travel in a given time or inside a given range, so as to define an area C in which there might be a risk of collision. The current collision risk area C is preferably calculated moment by moment, according to a moment by moment acquisition of information by the speed module 31, the steer module 32 and possibly the position module 34.

The risk area module 33 can calculate the extension and the boundaries of the collision risk area C performing a sum of the possible trajectories of the vehicle 2 or calculating a most far possible trajectory on the left C1 (with respect to the vehicle 2) and a most far possible trajectory on the right C2, and then defining the collision risk area C as the area comprised between the two most far possible trajectories. The collision risk area C can also be shared between different vehicles 2 by means of communication means connecting the respective apparatuses 1 of the vehicles 2; for example the communication means are radio transmission means.

The apparatus 1 preferably includes detection means 4, connected to the processing unit 3, to be placed on board of the vehicle 2, for example provided at its back portion, which detection means 4 are able to detect the positions of obstacles 5 within an area of interest A including the collision risk area C. Said area of interest A is a portion of the overall zone surrounding the vehicle 2, such as a portion of the semi-space the vehicle 2 faces backwards, i.e. an area A which includes the trajectories where the vehicle 2 can go when moving in reverse driving (see FIG. 2). Therefore, the above-defined collision risk area C is generally a portion of the area of interest A or, at most, correspond to the area of interest A.

In a preferred embodiment, the detection means 4 comprise at least an echo device, such as a radar device 3, able to determine the position of the objects. However, the detection means 4 can also or instead include an optical device, e.g. a laser device or the like, or an ultrasound device, etc . . . .

The processing unit 3 can comprise a check module 37 configured for verifying whether at least an obstacle 5 detected by the detection means 4 is inside the collision risk area C. A detected obstacle 5 is within the area of interest A and can be either within or outside the collision risk area C. If the detected obstacle 5 is within the collision risk area C, a collision is possible. This is a basic way the invention has to assess whether, upon an obstacle 5 detection, an action is required.

More refined ways of assessing plausible collision risk together with the possible actions to be taken and how to take those actions will be discussed in the following paragraphs. In a preferred embodiment of the invention, the processing unit 3 comprises an obstacle movement module 38 configured for calculating, preferably moment by moment, a movement direction and a speed parameter for each detected obstacle 5, according to its position variations detected by said detection means 4.

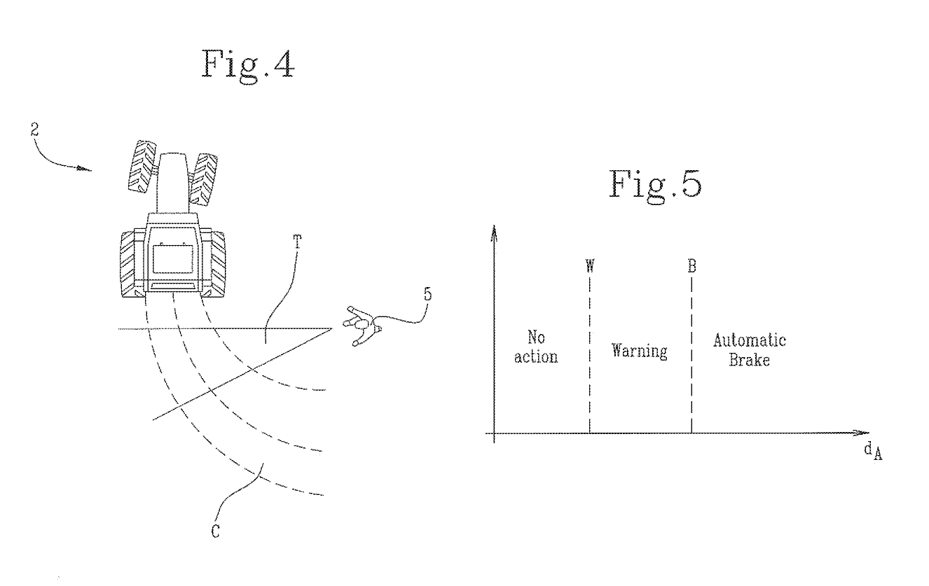

An obstacle travel module 39, can be also provided, such configured as to calculate possible trajectories of the detected obstacles 5, according to the respective movement direction and speed, so as to define possible travel areas T of the obstacles 5 (see FIG. 3). In this case, the processing unit 3 comprises an interception module 300 configured for verifying whether said collision risk area C substantially intersect with at least one of said travel areas T, thereby recognizing an actual collision risk for the vehicle 2 with moving obstacles 5, even if the latter are initially positioned outside the collision risk area C (see FIG. 4).

The invention collects information about current possible trajectories of obstacles 5 included in the area of interest A and, according to the current possible trajectories of the vehicle 2, verifies whether a collision risk is a concrete possibility, especially in the near future, i.e. in a short period of time.

If a collision event is forecast, before it actually occurs, action must be taken. Preferably, in order to decide which action has to be taken, the severity of risk collision is assessed by the processing unit 3; to this end, the processing unit 3 can comprise a distance module 301 configured for calculating a current distance between the vehicle 2 and the travel area T of each detected obstacle 5 or the obstacle 5 itself if the check module 37 detects it in the collision risk area C.

In the following paragraphs the distance calculated by the distance module 301 will be called collision distance.

A moving obstacle 5 “seen” by the check module 37 will itself have its own travel area T; should this area substantially intersect the collision risk area C, then that obstacle 5 is still relevant.

The interception module 300 can be configured for calculating the extension of the intersection between the area of interest A and the collision risk area C and disregarding intersections having an extension lower than a relevance threshold.

In detail, the distance module 301 can be configured for calculating the distances between vehicle 2 and the nearer border of the travel areas T of the detected obstacles 5 or the distance between the vehicle 2 and a central trajectory of the obstacle 5 or the distance between the vehicle 2 and a characteristic point inside the travel area T and so on.

In order to calculate the collision distance, as a reference position for the vehicle 2, the position of the detection means 4 or GPS coordinates or a pre-set conventional point or area in the vehicle 2 can be chosen.

Please note that the collision distance is not necessarily the “geometric distance” intended as the length straight segment or line joining the vehicle 2 and the obstacle 5.

If the plausible trajectories of the vehicle 2 are bent, i.e. are curves, then the collision distance is measured along a curved line or segment following the curvature (i.e. a mean curvature or the like) of the collision risk area C.

Also, the processing unit 3 can comprise a time module 302 configured for calculating a current time to collision, according to the collision distances calculated by the distance module 301 and according to the current speed of the vehicle 2 determined by the speed module 31.

Clearly, the time to collision is an estimate of the time remaining before the vehicle 2 possibly collide with at least an obstacle 5 in a situation already assessed as risky if not even dangerous.

Moreover, the processing unit 3 can comprise a brake module 303 configured to calculate a deceleration magnitude the vehicle 2 has to undergo to avoid a collision, according to the collision distances calculated by the distance module 301 and according to the current speed of the vehicle 2 determined by the speed module 31.

In practice, the obstacles 5 (or the risk of collision with that obstacle 5) can be classified according to respective time to collision and or the deceleration magnitude; in fact, different actions (or no action at all) can be taken based on how soon the vehicle 2 could collide with a given obstacle 5 (if nothing changes) or how much deceleration of the vehicle 2 is needed in order to realistically avoid a coalition with a given obstacle 5. Therefore, critical or classifying thresholds of time to collision and/or deceleration magnitude can be defined in order to identify different classes of detected obstacles 5 (or collision risks relative to the obstacles 5) with respect to that vehicle 2 in a given moment.

In detail, the processing unit 3 can comprise an action module 304 configured to produce a warning notice, preferably destined to alert the driver of the vehicle 2, upon at least a positive verification by means of the time module 302 that the time to collision relating to at least a detected obstacle 5 is lower than a warning threshold and/or a positive verification by means of the brake module that the deceleration magnitude relating to at least a detected obstacle 5 is higher than a warning threshold W (see FIG. 5).

In practice, the warning notice can be a signal that the processing unit 3 sends directly or indirectly (e.g. via the ECU) to warning means preferably included in the driver's cab. The warning means can be able to emit sounds or visual warnings (or even tactile warnings such as a vibrations or the like). The warning means can be integrated in the usual equipment of the vehicle 2 or can be provided separately from this equipment.

In a particular embodiment, the action module 304 is configured for sending at least a brake signal suitable to command an automatic braking of the vehicle 2, upon at least a positive verification by means of the time module the time to collision relating to at least a detected obstacle 5 is lower than a braking threshold and/or a positive verification by means of the brake module that the deceleration magnitude relating to at least a detected obstacle 5 is higher than a braking threshold B. Accordingly, if a braking of the vehicle 2 is forced by the processing unit 3 upon the verification that the deceleration magnitude has reached a pre-set braking threshold B, the brake signal would command an automatic braking having the corresponding deceleration magnitude.

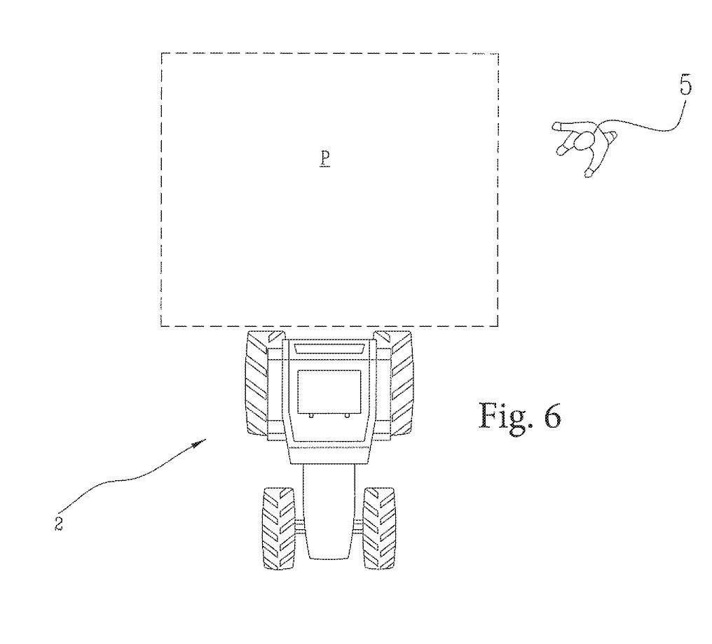

The invention can also be able to deal with a sudden appearance of an obstacle 5 very close to the vehicle 2, which implies a sudden action performed by the processing unit 3. To this end the check module 37 can be configured for verifying if an obstacle 5 is inside a proximity range P, i.e. inside a pre-determined proximity range from the vehicle 2 (see FIG. 6). In this case, the action module 304 is configured for sending a maximum brake signal (e.g. to the ECU) suitable to command an automatic braking of the vehicle 2 with the maximum possible deceleration, upon the positive verification by the check module 37 that an obstacle 5 is detected inside the proximity range. In other words, if an obstacle 5 is currently too close to the vehicle 2, i.e. its proximity is classified as too close to be dealt with otherwise, the invention will cause the vehicle 2 to stop right away trying to avoid a collision, if physically possible.

The functioning of a preferred embodiment of the invention is as described below.

The vehicle 2 is travelling e.g. on a construction site, where buildings, pedestrian workers, poles, workers on scooters or bicycles are also travelling, and so on . . . . The vehicle 2 might be running backwards and the processing unit 3 calculates moment-by-moment plausible trajectories in order to anticipate possible collision paths, or zones, in the surrounding environment.

In the meanwhile, the detection means 4 look for possible obstacles 5, e.g. in the backward semi-space defined by the backside of the vehicle 2 or anyway in an area of interest A. If moving obstacles 5 are detected, then their possible/plausible trajectories are calculated in order to check if the travel areas T, in which the obstacle 5 are going to be found, intersect the collision risk area C defined by the plausible trajectories of the vehicle 2, meaning that an actual risk of collision in a near future can be forecast.

According to the proximity of a travel area T (the nearer one, for example) and the speed of the vehicle 2, the processing unit 3 can choose to: take no action, send a warning alert to the driver or automatically brake the vehicle 2. In case of a sudden obstacle 5 detected extremely close to the vehicle 2 a powerful braking is performed right away.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An apparatus for automatic collision avoidance, to be provided on a vehicle, comprising:
a detection means for detecting positions of obstacles within an area of interest; and
a processing unit, the processing unit comprising:
a position module configured for acquiring a current position of the vehicle;
a speed module configured for acquiring a current speed of the vehicle;
a steer module configured for acquiring a current steering degree of the vehicle; and
a risk area module configured for calculating current possible trajectories of the vehicle according to values of said current position, speed and steering degree, thereby defining a current collision risk area, wherein the area of interest is included within the current collision risk area;
an obstacle movement module configured for calculating a movement direction and a speed parameter for each detected obstacle, according to its position variations detected by said detection means;
an obstacle travel module configured for calculating possible trajectories of the detected obstacles, according to the respective movement direction and speed, so as to define possible travel areas of the obstacles;
an interception module configured for verifying whether said collision risk area substantially intersect with at least one of said travel areas; and
a distance module configured for calculating a current distance between the vehicle and the travel area of each detected obstacle.

2. The apparatus according to claim 1, wherein the risk area module calculates a most far possible trajectory on the left and a most far possible trajectory on the right, defining said collision risk area as the area comprised between said most far possible trajectories.

3. The apparatus according to claim 1, further comprising a communication means for connecting said processing unit with another processing unit to share said collision risk area with the another processing unit.

4. The apparatus according to claim 1, wherein the processing unit further comprises a check module configured for verifying whether at least a detected obstacle is inside the collision risk area.

5. The apparatus according to claim 4, wherein the distance module is further configured for calculating a current distance between the vehicle and a detected obstacle, if the check module has detected it in the collision risk area.

6. The apparatus according to claim 5, wherein the processing unit further comprises a time module configured for calculating a current time to collision, according to distances calculated by the distance module and according to the current speed of the vehicle determined by the speed module.

7. The apparatus according to claim 6, wherein the processing unit further comprises a brake module configured to calculate a deceleration magnitude the vehicle has to undergo to avoid a collision, according to the distances calculated by the distance module and according to the current speed of the vehicle determined by the speed module.

8. The apparatus according to claim 7, wherein the processing unit further comprises an action module configured to produce a warning notice, upon at least a positive verification by means of the time module that the time to collision relating to at least a detected obstacle is lower than a warning threshold.

9. The apparatus according to claim 8, wherein the action module is further configured to produce a warning notice, upon at least a positive verification by means of the brake module that the deceleration magnitude relating to at least a detected obstacle is higher than a warning threshold.

10. The apparatus according to claim 8, wherein the action module is further configured for sending at least a brake signal suitable to command an automatic braking of the vehicle, upon at least a positive verification by means of the time module that the time to collision relating to at least a detected obstacle is lower than a braking threshold.

11. The apparatus according to claim 8, wherein the action module is configured for sending at least a brake signal suitable to command an automatic braking of the vehicle, upon positive verification by means of the brake module that the deceleration magnitude relating to at least a detected obstacle is higher than a braking threshold.

12. The apparatus according to claim 4, wherein the check module is further configured for verifying whether a detected obstacle is inside a proximity range, and wherein the processing unit comprises an action module configured for sending a maximum brake signal suitable to command an automatic braking of the vehicle with the maximum possible deceleration, upon at least a positive verification by said check module.
